(19) United States
(12) Patent Application Publication
(10) Pub. No.: US 2011/0189375 A1
(43) Pub. Date: Aug. 4, 2011

(54) Method for Manufacturing Formed Lumps of Shellfish Meat

(75) Inventor: Tran Huu TAM, Khanh Hoa Province (VN)

(73) Assignee: Phillips Foods, Inc., Baltimore, MD (US)

(21) Appl. No.: 12/699,475

(22) Filed: Feb. 3, 2010

(51) Int. Cl. A23L 1/33; A23P 1/12

(52) U.S. Cl. 426/643; 426/388

(57) ABSTRACT

A method for manufacturing formed lumps of shellfish meat may include providing cooked shellfish meat and raw shellfish meat. The cooked and raw shellfish meat may be combined together to create a mixture of the cooked shellfish meat and raw shellfish meat. The mixture of raw and cooked shellfish meat may be shaped to a desired shape and cooked. After cooking, the shaped mixture may be separated into a plurality of formed lumps of shellfish meat. The shellfish meat, may include, but is not limited to, crab, scallops, shrimp, and lobster.

### BACKGROUND OF THE INVENTION

1. Field of the Invention

The present invention relates to a method of manufacturing pieces of shellfish meat, such as crab meat, into formed lumps.

2. Background Art

Jumbo lumps of certain shellfish meat, such as crab meat for example, are more desirable to consumers, and therefore are more commercially valuable and command a higher sales price than smaller lumps or loose flakes thereof. In the instance of crab meat, in order to obtain the jumbo lumps of meat from the two back fins of the crab, professional pickers are required who have acquired the skill of removing jumbo lumps intact. The lump meat is only found in the fins of the crab, leaving only a small percentage of the meat from each crab used. In addition, professional pickers are required to remove the jumbo lumps. Utilizing only a small percentage of the meat from each crab and having professional pickers remove jumbo lumps is costly and time consuming, so processes for joining smaller pieces of meat together to create formed lumps have been developed. However, there is a continuing need for new methods to create formed lumps from smaller pieces of meat that resemble a natural lump of meat as well as to add value to lower grade meat.

### BRIEF SUMMARY OF THE INVENTION

A method for manufacturing formed lumps of shellfish meat may include providing cooked shellfish meat and raw shellfish meat and then combining the cooked and raw shellfish meat together to create a mixture. Then the mixture of raw and cooked shellfish meat may be shaped to a desired shape and cooked. After cooking, the shaped mixture may be separated into a plurality of formed lumps of shellfish meat. The shellfish meat, may include, but is not limited to, crab, scallops, shrimp, and lobster.

### BRIEF DESCRIPTION OF THE DRAWINGS/FIGURES

The accompanying drawings, which are incorporated herein and form a part of the specification, illustrate the present invention by way of example, and not by way of limitation. The drawings together with the description, further serve to explain the principles of the invention and to enable a person skilled in the pertinent art to make and use the invention.

FIG. 1 is a flow chart of an exemplary method for manufacturing formed lumps of shellfish meat, in accordance with one embodiment according to the present invention.

FIG. 2 illustrates an exemplary method for shaping a mixture of shellfish meat with a syringe, in accordance with one embodiment according to the present invention.

FIG. 3 illustrates an another exemplary method for shaping a mixture of shellfish meat with a tube, in accordance with one embodiment according to the present invention.

FIG. 4 illustrates an exemplary method for removing shaped shellfish meat from the tube shown in FIG. 3, in accordance with one embodiment according to the present invention.

FIG. 5 illustrates exemplary shaped cylindrical rods of shellfish meat once removed from the tube shown in FIG. 3, in accordance with one embodiment according to the present invention.

FIG. 6 illustrates a plurality of formed lumps of shellfish meat made in accordance with one embodiment according to the present invention.

### DETAILED DESCRIPTION OF THE INVENTION

The present invention will be described with reference to the accompanying drawings, in which like reference numerals refer to similar elements. While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

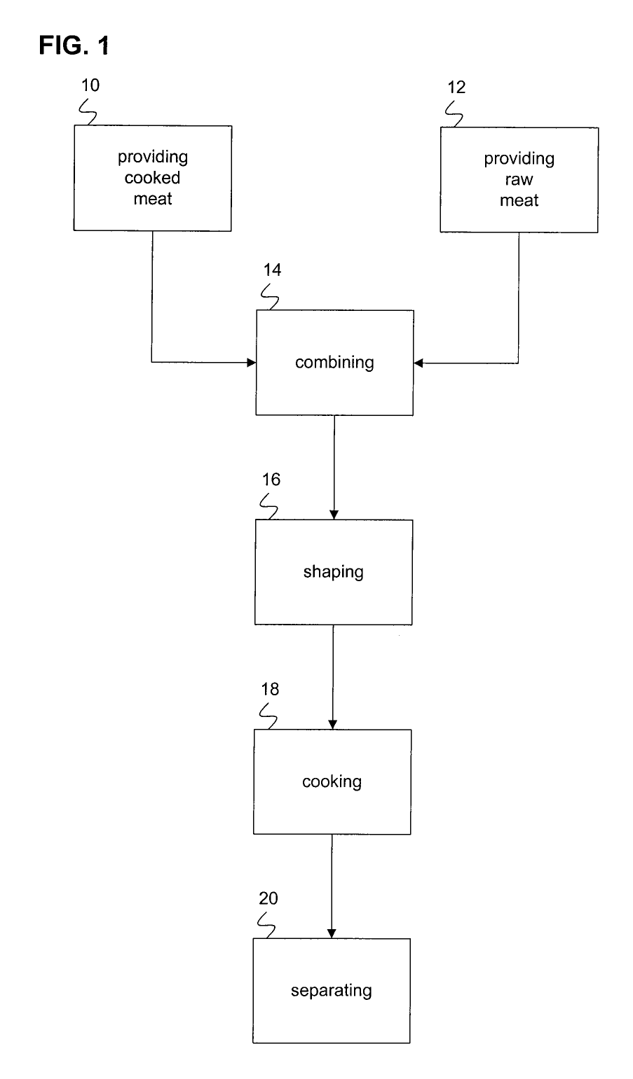

FIG. 1 is a flowchart of an exemplary method for manufacturing formed lumps of shellfish meat. The shellfish meat, may include, but is not limited to, crab, scallops, shrimp, and lobster. Cooked shellfish meat and raw shellfish meat may be provided (steps 10 and 12, respectively). Cooked shellfish meat, as used herein, is defined as shellfish meat that has been partially or fully cooked. Raw shellfish meat, as used herein, is defined as shellfish meat that has not been cooked. Pieces of the cooked and raw shellfish meat may be combined to create a mixture of the cooked shellfish meat and raw shellfish meat (step 14). The mixture of raw and cooked shellfish meat may be shaped to a desired shape (step 16) and cooked (step 18). After cooking, the mixture may be separated into individual formed lumps of a desired size, shape, and/or weight (step 20).

The method may include a step 10 of providing cooked shellfish meat. The cooked shellfish meat may include crab, scallops, shrimp, and lobster. In one embodiment, the cooked shellfish meat may be crab, such as special crab meat, claw crab meat, other grades of crab meat, or combinations thereof. When the cooked shellfish meat is crab, step 10 of providing cooked crab meat may include receiving a previously cooked crab, such as a boiled or steamed crab. The cooked crab may be de-backed to remove the shell of the crab. Once the crab is de-backed, cooked meat pieces or flakes may be picked from the crab. The picked crab pieces may then be placed under a black light to aid in removing pieces of shell that remain attached to the cooked crab meat.

The method may also include a step 12 of providing raw shellfish meat. The raw shellfish meat may include the same type of meat as the cooked shellfish meat, such as, for example, crab, scallops, shrimp, and lobster. When the raw shellfish meat is crab, the crab meat may be white crab meat, claw, claw knuckle, or combinations thereof. In some embodiments, the raw crab meat may be Portunus pelagicus spp., mud crabs, such as crabs of the genus Scylla, or combinations thereof. When the raw shellfish meat is crab, step 12 of providing raw crab meat may include receiving a raw, uncooked crab. The raw, uncooked crab may be de-backed to remove the shell of the crab. Once the crab is de-backed the crab may be cleaned under running water. After cleaning, the crab may be placed on ice to chill the crab at a predetermined temperature, for example about 4 degrees Celsius, for a predetermined amount of time, for example at least 5 hours. Raw meat may then be picked from the body of the crab. The picked raw meat may be constantly chilled, for example at a temperature at or below 10 degrees Celsius. The picked raw meat may then be placed under a black light to aid in removing pieces of shell that remain attached to the raw meat crab meat. The picked raw meat may resemble a paste.

The method may also include a step 14 of combining the cooked and raw shellfish meat to form a mixture. The raw shellfish meat may act as a paste or glue to hold the pieces of the cooked shellfish meat together. In one embodiment, the cooked shellfish meat and raw shellfish meat may be weighed to combine them in a predetermined ratio, for example from about 10% raw crab meat and 90% cooked crab meat to about 50% raw crab meat and 50% cooked crab meat. For example, the mixture may include about 10% raw crab meat and about 90% cooked crab meat, about 15% raw crab meat and about 85% cooked crab meat, about 25% raw crab meat and about 75% cooked crab meat, or about 50% raw crab meat and about 50% cooked crab meat. In some embodiments, step 14 of combining includes blending the raw and cooked shellfish meat by hand. In some embodiments, step 14 of combining includes blending the raw and cooked shellfish meat by hand and then grinding the blended meat in a grinder or mincing machine for a predetermined amount of time, such as from about 3 seconds to about 5 seconds.

The method may also include a step 16 of shaping the mixture into a desired shape and a step 18 of cooking the mixture. The combined steps 16 and 18 may be performed in a variety of manners.

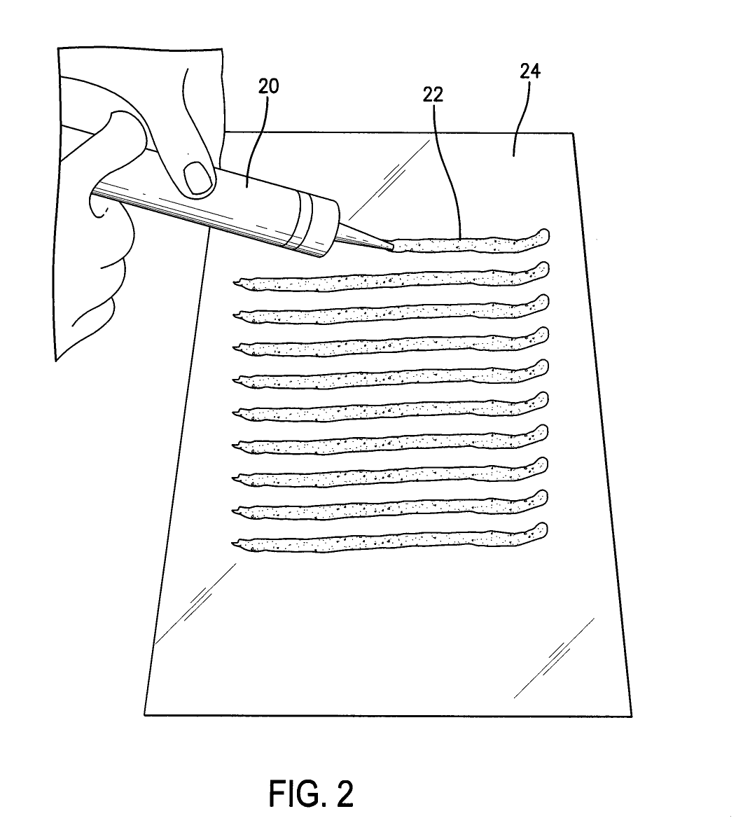

In one embodiment, as shown for example in FIG. 2, step 16 of shaping may include placing the mixture of shellfish meat into a syringe 22. Syringe 22 allows the mixture of shellfish meat to be shaped by dispensing strips 24 of the mixed shellfish meat from syringe 22. Syringe 22 may have a volume, for example, of about 60 cubic centimeters (cc). A plurality of strips 24 may be dispensed from syringe 22 onto a sheet 24, for example a plastic sheet, such as polyethylene. A plurality of sheets 24, each with a plurality of strips 24 dispensed thereon, may be stacked and placed in a container for cooking. Strips 24 may resemble the shape and size of natural lump meat. In this embodiment, step 18 of cooking may include steaming strips 24 of mixed shellfish meat for a predetermined time, for example about 3 minutes. Alternatively, step 18 of cooking may include boiling strips 24 for a predetermined time. In this embodiment, the mixture of shellfish meat may include about 25% raw crab meat and about 75% cooked crab meat.

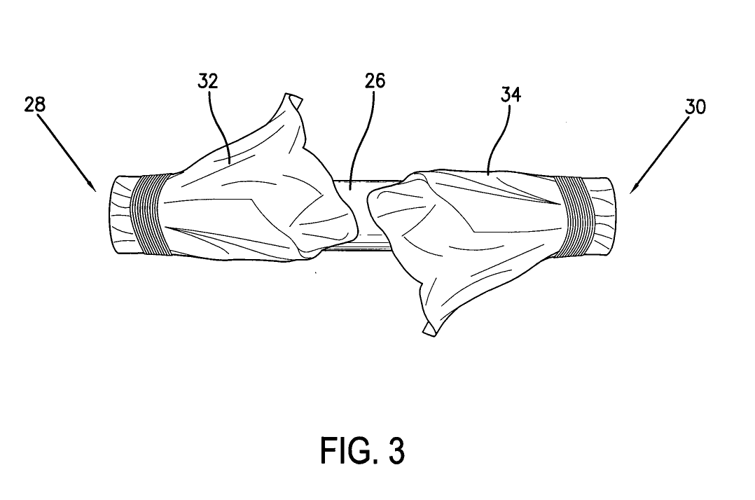

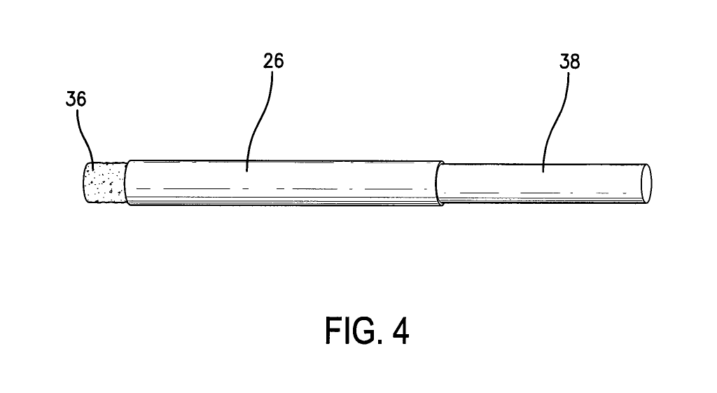

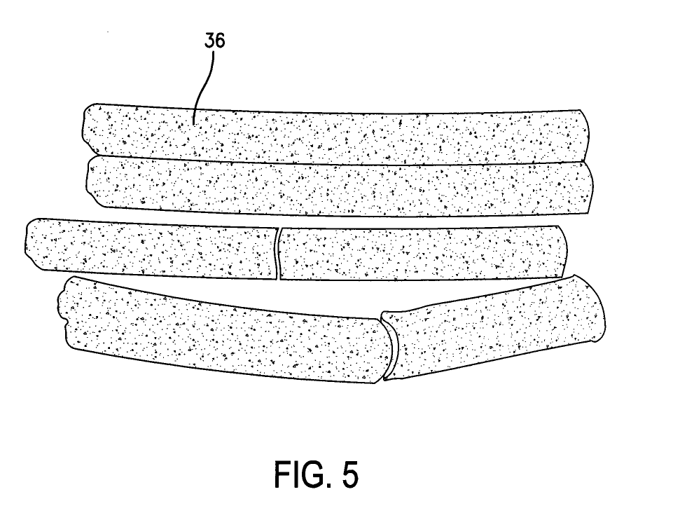

In another embodiment, as shown for example in FIGS. 3-5, step 16 of shaping may include placing the mixture of shellfish meat into a hollow tube 26, for example a cylindrical tube, having open ends 28 and 30. The mixture of shellfish meat is stuffed into tube 26 to shape the mixture to the interior space of tube 26, for example, a substantially cylindrical rod. Tube 26 may be stainless steel. In some embodiments, tube 26 may have a length of about 10 inches and a diameter between about 0.75 inch and 1.0 inch. Ends 28 and 30 of tube 26 may be secured, for example with plastic films or sheets 32 and 34, to prevent the mixture of shellfish meat from falling out of tube 26 during cooking. The material for plastic films or sheets 32 and 34 are selected to withstand cooking for the desired cooking time and temperature in order to avoid melting of plastic films or sheets 32 and 34. In other embodiments, ends 28 and 30 of tube 26 may be covered with lids (not shown), for example stainless steel lids. A plurality of stuffed tubes 26 may be placed in a container for cooking. In this embodiment, step 18 of cooking may include boiling tubes 26 stuffed with the mixture of shellfish meat for a predetermined time, for example between about 10 minutes and about 20 minutes, such as for example about 15 minutes. Alternatively, step 18 of cooking may include steaming tubes 26 stuffed with the mixture of shellfish meat for a predetermined time, for example from about 10 minutes to about 20 minutes. After cooking, plastic films 32 and 34 may be removed from ends 28 and 30 of tube 26 so that substantially cylindrical rods 36 of shellfish meat may be removed. A cylindrical punch 38 having a diameter slightly smaller than a diameter of tube 26 may be inserted into one end of tube 26 to aid in pushing cylindrical rods 36 of shellfish meat out of tube 26. In this embodiment, the mixture of shellfish meat may include about 10% raw crab meat and about 90% cooked crab meat.

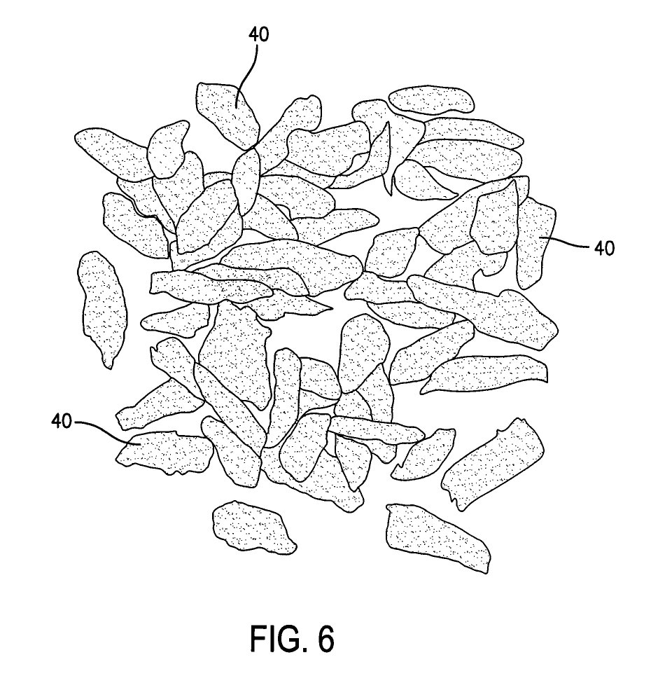

The method may also include a step 20 of separating the shaped shellfish meat after step 18 of cooking into a plurality of formed lumps of shellfish meat. Step 20 may include breaking the shaped shellfish meat, such as strips 24 or rods 36 by hand or with a cutting implement, such as a knife. Step 20 may occur after allowing the shaped shellfish meat to cool from step 18 of cooking for a predetermined time on ice, for example, about 5 minutes. FIG. 6 shows an exemplary plurality of formed lumps 40 of shellfish meat. Formed lumps 40 of shellfish meat may be formed to a desired shape, size, and/or weight. In some embodiments, each of formed lumps 40 weigh in a range from about 0.5 gram to about 13 grams or in a range from about 6 grams to about 10 grams. In other embodiments, each of formed lumps 40 may weigh in a range from about 0.5 grams to about 1.5 grams. In some embodiments, formed lumps 40 contain no ingredients other than crab meat such that formed lumps 40 are 100% crab meat.

Thus, a method for manufacturing formed lumps of shellfish meat may include providing cooked shellfish meat and raw shellfish meat and combining the cooked and raw shellfish meat together to create a mixture. Next, the mixture of raw and cooked shellfish meat may be shaped to a desired shape and cooked. After cooking, the shaped mixture may be separated into a plurality of formed lumps of shellfish meat.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for making formed lumps of shellfish meat comprising the steps of:
providing cooked shellfish meat;
providing raw shellfish meat;
combining the cooked shellfish meat and the raw shellfish meat into a mixture;
shaping the mixture into a desired shape;
cooking the mixture; and
separating the cooked mixture into a plurality of formed lumps of shellfish meat.

2. The method according to claim 1, wherein the step of shaping the mixture comprises:
placing the mixture into a syringe; and
dispensing strips of mixture from the syringe.

3. The method according to claim 2, wherein the step of combining comprises grinding the cooked shellfish meat and the raw shellfish meat together.

4. The method according to claim 2, wherein the mixture comprises about 25% raw crab meat and about 75% cooked crab meat.

5. The method according to claim 2, wherein the syringe has a volume of about 60 cc.

6. The method according to claim 2, wherein the step of cooking comprises steaming.

7. The method according to claim 6, wherein the mixture is steamed for about 3 minutes.

8. The method according to claim 1, wherein:
the step of shaping the mixture comprises sealing the mixture in a tube;
the step of cooking occurs while the mixture is in the tube; and
the cooked mixture is removed from the tube in the form of a substantially cylindrical rod.

9. The method according to claim 8, wherein the mixture comprises about 10% raw crab meat and about 90% cooked crab meat.

10. The method according to claim 8, wherein the tube comprises stainless steel.

11. The method according to claim 8, wherein ends of the tube are sealed by securing a plastic film over the ends of the tube.

12. The method according to claim 8, wherein the step of cooking comprises boiling.

13. The method according to claim 12, wherein mixture is boiled for about 15 minutes.

14. The method according to claim 1, wherein the shellfish meat is selected from the group consisting of crab, scallops, shrimp, and lobster.

15. The method according to claim 1, wherein the cooked shellfish meat comprises special crab meat.

16. The method according to claim 1, wherein the formed lumps of shellfish meat are 100% crab meat.

17. A formed lump of shellfish meat made according to a method comprising the steps of:
providing cooked shellfish meat;
providing raw shellfish meat;
combining the cooked shellfish meat and the raw shellfish meat into a mixture;
shaping the mixture into a desired shape;
cooking the mixture; and
separating the cooked mixture into a plurality of formed lumps of shellfish meat.

18. The formed lump of shellfish meat of claim 17, wherein the formed lump of shellfish meat is 100% crab meat.

19. The formed lump of shellfish meat of claim 17, wherein the formed lump of shellfish meat weighs in a range from about 0.5 gram to about 13 grams.

20. The formed lump of shellfish meat of claim 19, wherein the formed lump of shellfish meat weighs in a range from about 0.5 gram to about 1.5 grams.
